(19) United States
(12) Patent Application Publication
(10) Pub. No.: US 2025/0287352 A1
(43) Pub. Date: Sep. 11, 2025

(54) SYSTEMS AND METHODS FOR SUBSCRIPTION-BASED PRIORITY ACCESS AND SERVICES IN A WIRELESS NETWORK

(71) Applicant: Verizon Patent and Licensing Inc., Basking Ridge, NJ (US)

(72) Inventors: Shanthala Kuravangi-Thammaiah, Keller, TX (US); Ambreen Habib, Golden, CO (US)

(73) Assignee: Verizon Patent and Licensing Inc., Basking Ridge, NJ (US)

(21) Appl. No.: 18/598,677

(22) Filed: Mar. 7, 2024

(51) Int. Cl. H04W 68/02; H04W 8/20; H04W 28/02

(52) U.S. Cl. CPC H04W 68/02; H04W 8/20; H04W 28/0268

(57) ABSTRACT

A system may maintain subscription information associated with a plurality of User Equipment (“UEs”), which may include priority level information, such as one or more access identities, associating a UE with one or more respective priority levels. The system may receive, from a network function (“NF”) of a wireless network, a request for priority level information associated with the UE, and may identify a particular set of priority levels indicated by the subscription information as being associated with the UE. The system may output the identified particular set of priority levels to the NF. The NF may maintain policy information associating the particular set of priority levels with one or more network parameters and may implement the one or more network parameters when providing service associated with the UE. The system may include a Unified Data Management function (“UDM”) or a Unified Data Repository (“UDR”) of the wireless network.

### BACKGROUND

Wireless networks provide wireless connectivity to User Equipment (“UEs”), such as mobile telephones, tablets, Internet of Things (“IoT”) devices, Machine-to-Machine (“M2M”) devices, or the like. Different UEs or users thereof may be associated with different categories or groups, such as “first responder,” “enterprise user,” “streaming device,” etc. These different categories or groups may be indicative of different levels services provided by a wireless network, such as different Quality of Service (“QoS”) parameters, different queuing parameters, different load balancing parameters, or the like.

### BRIEF DESCRIPTION OF THE DRAWINGS

FIG. 1 illustrates an example overview of one or more embodiments described herein;

FIG. 2 illustrates example UE priority level information and/or policies, in accordance with some embodiments;

FIG. 3 illustrates an example of providing subscription-based priority access information, associated with one or more UEs, to one or more network functions (“NFs”) of a wireless network, in accordance with some embodiments;

FIG. 4 illustrates an example of automatically providing updated subscription-based priority access information to one or more NFs of a wireless network, in accordance with some embodiments;

FIG. 5 illustrates example NFs that may utilize UE priority level information and/or policies when providing network connectivity to one or more UEs, in accordance with some embodiments;

FIG. 6 illustrates an example signal flow for providing subscription-based priority access to a UE in a wireless network, in accordance with some embodiments;

FIG. 7 illustrates an example process for providing subscription-based priority access to a UE in a wireless network, in accordance with some embodiments;

FIGS. 8 and 9 illustrate example environments in which one or more embodiments, described herein, may be implemented;

FIG. 10 illustrates an example arrangement of a radio access network (“RAN”), in accordance with some embodiments; and

FIG. 11 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Wireless networks may implement mechanisms by which different levels of access, QoS parameters, or the like may be provided to UEs that receive wireless connectivity from such wireless networks. Such mechanisms may include implementing network slices, Data Network Name (“DNNs”), access lists, and/or other suitable mechanisms that are associated with different sets of parameters. Embodiments described herein provide for a granular, per-UE subscription-based mechanism for indicating different priority levels with which one or more UEs are associated. As discussed herein, the different priority levels may be used by the wireless network (e.g., by a RAN of the wireless network and/or a core of the wireless network) to provide different QoS parameters, access parameters, etc. to different UEs.

As also discussed herein, UE priority level information may be maintained by one or more network elements that are configured to maintain UE subscription information, such as a Unified Data Management function (“UDM”) and/or a Unified Data Repository (“UDR”). Maintaining such information by such network elements may allow for other NFs of the wireless network to obtain priority level information on a per-UE basis, and to accordingly provide service to UEs based on respective priority levels. In some embodiments, the NFs may use Service-Based Interfaces (“SBIs”) to obtain the UE priority level information from the UDM and/or the UDR (herein referred to as “UDM/UDR” for brevity). Further, NFs of the wireless network may be automatically updated when subscription information associated with a particular UE (e.g., including UE priority level information) is updated at the UDM/UDR (e.g., by an administrator or operator of the wireless network).

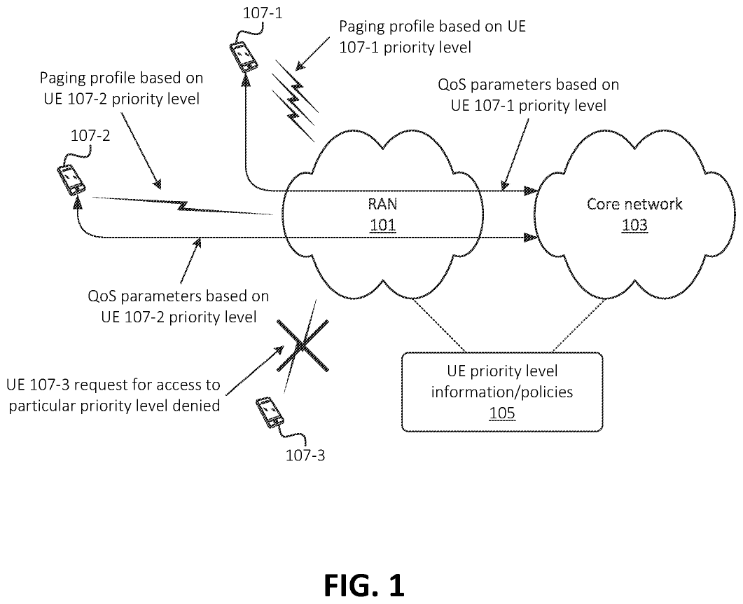

For example, as shown in FIG. 1, RAN 101 and/or core network 103 (e.g., which may be associated with the same wireless network) may maintain UE priority level information/policies 105. As discussed above, UE priority level information may be maintained on a per-UE basis. In this example, assume that UE priority level information/policies 105 include UE priority level information for UEs 107-1, 107-2, and 107-3. For example, UE priority level information/policies 105 may indicate that UE 107-1 is associated with (e.g., authorized for) a first priority level or set of priority levels, that UE 107-2 is associated with a second priority level or set of priority levels, and that UE 107-3 is associated with a third priority level or set of priority levels.

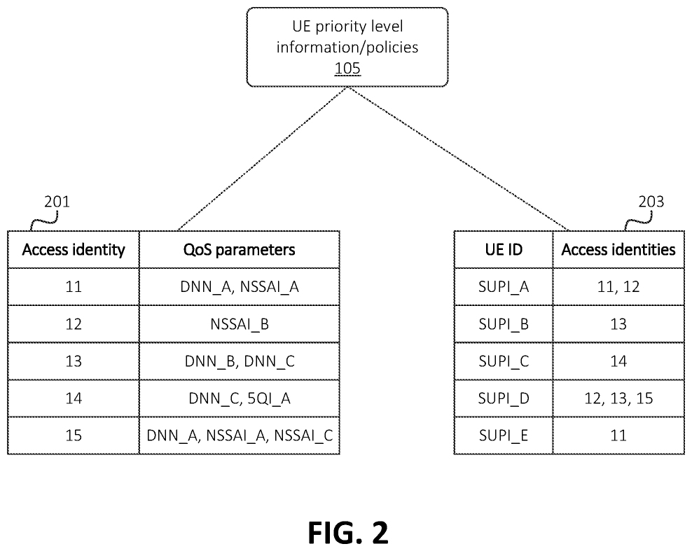

FIG. 2 illustrates example UE priority level information/policies 105 that may be maintained by one or more elements of RAN 101 and/or core network 103. In this example, UE priority level information/policies 105 may include priority level policies (e.g., as represented in data structure 201) and/or UE priority level information (e.g., as represented in data structure 203). In some embodiments, UE priority level information/policies 105 may indicate respective priority levels using access identities or other suitable identifiers. For example, a first access identity (e.g., access identity “11”) may be associated with a first priority level, a second access identity (e.g., access identity “12”) may be associated with a second priority level, a third access identity (e.g., access identity “13”) may be associated with a third priority level, a fourth access identity (e.g., access identity “14”) may be associated with a fourth priority level, and a fifth access identity (e.g., access identity “15”) may be associated with a fifth priority level. In some embodiments, additional, fewer, and/or different access identities may be associated with different priority levels. In some embodiments, other priority level identifiers may be used in addition to, or in lieu of, access identities.

As shown, data structure 201 may include information associating particular access identities with particular sets of QoS parameters. In this example, QoS parameters may refer to different network slices (e.g., Network Slice Selection Assistance Information (“NSSAI”) values or other suitable network slice identifiers), Data Network Names (“DNNs”), 5G QOS Identifiers (“5QIs”), or other suitable values. As shown, a particular access identity may be associated with one set of QoS parameters or multiple sets of QoS parameters. As discussed below, different network elements may use priority level policies (e.g., data structure 201) when handling, forwarding, queuing, processing, etc. traffic sent to or received from UEs 107 that are associated with particular access identities.

Additionally, or alternatively, in some embodiments, other types of policies or QoS parameters may be associated with particular access identities or other priority level identifiers. For example, in some embodiments, the priority level policies may include RAN paging profiles and/or other RAN-specific parameters. For example, a particular RAN paging profile may indicate how often a given UE 107 should be paged, located, etc. by one or more elements of RAN 101, such as in situations where downlink data is to be sent to such UE 107 (e.g., based on receiving a downlink data notification from core network 103). For example, a first paging profile may indicate that a given UE 107 should be notified as soon as possible when a downlink data notification is received, while a second paging profile may indicate that a given UE 107 should not be paged more than a maximum threshold frequency (e.g., not more than once per minute, not more than once per 30 seconds, etc.). As another example, the RAN-specific parameters may include RAN radio resource allocation parameters, queuing parameters, 5G QOS Identifier (“5QI”) values, and/or other suitable RAN-specific parameters.

Examples herein are discussed in the context of QoS parameters. In practice, similar concepts may apply for any suitable type of network parameter that is used by network elements to route, forward, process, filter, handle, etc. traffic sent to or sent by one or more UEs 107, in accordance with identifying respective priority levels associated with such UEs 107.

In some embodiments, different elements of RAN 101 and/or core network 103 may maintain different portions or subsets of priority level policy information (e.g., as represented by data structure 201). For example, one or more elements of RAN 101 may maintain information associating particular access identities with respective paging profiles, while one or more elements of core network 103 may maintain information associating particular access identities with respective QoS parameters but may not maintain information associating particular access identities with respective paging profiles.

As further shown in FIG. 2, UE priority level information may be represented by data structure 203, which may include information associating different UEs 107 with corresponding priority levels or sets of priority levels. As noted above, in this example, respective access identities may be associated with respective priority levels. In some embodiments, other types of identifiers or indicators may be used in addition to, or in lieu of, access identities. Further, in this example, Subscription Permanent Identifiers (“SUPIs”) may be used to distinguish between different UEs 107. In some embodiments, additional or different identifiers may be used to identify different UEs 107, such as a Globally Unique Temporary Identifier (“GUTI”), an International Mobile Subscriber Identity (“IMSI”), an International Mobile Station Equipment Identity (“IMEI”), an Mobile Directory Number (“MDN”), or the like.

In this example, as shown in data structure 203, a first UE (e.g., associated with example identifier SUPI_A) may be associated with two different priority levels (e.g., indicated as access identities 11 and 12), a second UE (e.g., associated with example identifier SUPI_B) may be associated with a particular priority level (e.g., indicated as access identity 13), and so on. As discussed below, the association of a given UE 107 with one or more access identities (and/or other priority level identifiers) may indicate that such UE 107 is authorized to request and/or receive service in accordance with such access identities. For example, the particular UE 107 with the identifier SUPI_A may be authorized to receive QoS parameters associated with access identities 11 and 12 (e.g., DNN_A, NSSAI_A, and/or NSSAI_B).

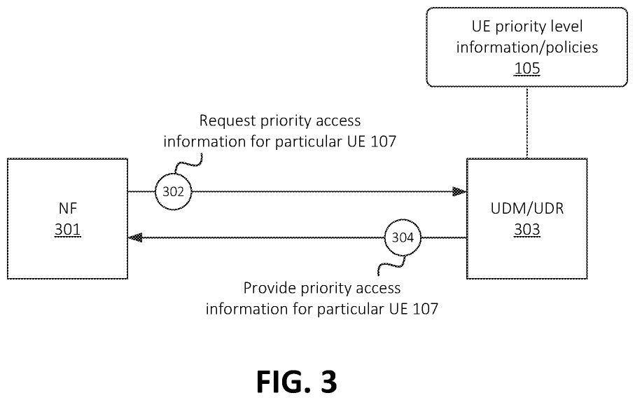

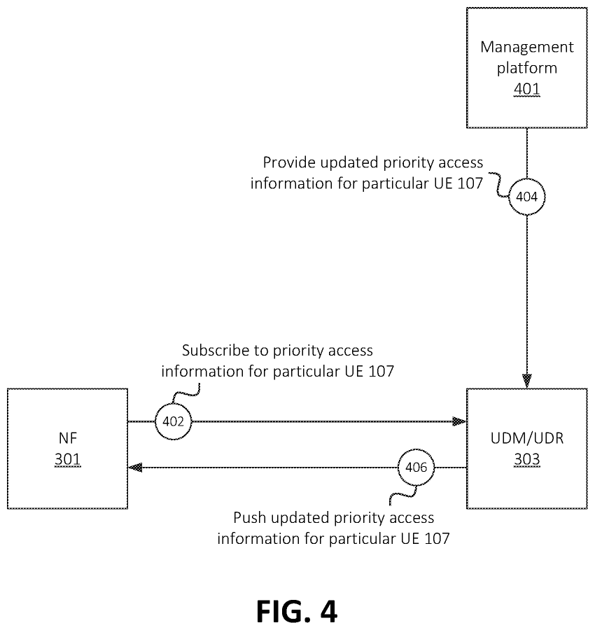

As shown in FIGS. 3 and 4, one or more NFs 301 may receive priority access information for one or more UEs 107 from UDM/UDR 303, and may use the priority access information when providing service to such UEs 107. For example, such NFs 301 may implement QoS parameters, queuing parameters, routing or forwarding parameters, etc. for traffic associated with a given UE 107 based on identifying one or more priority levels with which UE 107 is associated.

As shown in FIG. 3, a particular NF 301 may request (at 302) priority access information for a particular UE 107. NF 301 may, for example, output such request via an SBI associated with UDM/UDR 303, such as an Nudr interface, an Nudm interface, or some other suitable interface. NF 301 may output (at 302) the request based on a suitable triggering event or condition, such as identifying a communication session request associated with UE 107, receiving traffic to be forwarded to UE 107, etc. In some embodiments, the request (at 302) may include an identifier of UE 107, such as a SUPI, a GUTI, an MDN, and/or some other suitable identifier. In some embodiments, the request (at 302) may include a “GET” message or other suitable type of message.

UDM/UDR 303 may maintain UE priority level information/policies 105, and/or information derived from or represented by UE priority level information/policies 105. UDM/UDR 303 may also maintain other suitable subscription information associated with one or more UEs 107. UDM/UDR 303 may be “trusted” from the standpoint of NFs 301 of RAN 101 and/or core network 103, inasmuch as subscription information received from UDM/UDR 303 (e.g., including UE priority level information) may be considered as valid for use by NFs 301. For example, access to provide or update information to UDM/UDR 303 may be securely managed via one or more suitable security mechanisms.

UDM/UDR 303 may respond (at 304) to the request with priority access information for UE 107. For example, UDM/UDR 303 may identify one or more entries in data structure 203 (or some other suitable data structure) that correspond to UE 107, and may indicate which access identities or other priority level identifiers are authorized for UE 107. In some situations, UDM/UDR 303 may identify that UE 107 is not associated with any access identities or other priority level identifiers, and may indicate (at 304) that UE 107 is not associated with any access identities or other priority level identifiers. In some embodiments, UDM/UDR 303 may output (at 304) a “200 OK” message or other suitable type of message.

As shown in FIG. 4, in some embodiments, one or more NFs 301 may subscribe (at 402) to priority access information for one or more UEs 107. For example, NF 301 may output a request or indication to UDM/UDR 303 (e.g., via an Nudr interface, an Nudm interface, or some other suitable interface) requesting automatic updates to priority access information associated with UE 107 when UDM/UDR 303 receives updates to such information (e.g., modifications to access identities or other suitable priority level identifiers with which UE 107 is associated). At some point, UDM/UDR 303 may receive (at 404) updated priority access information for UE 107. For example, UDM/UDR 303 may receive such information from management platform 401 or some other suitable device or system that is authorized to update or modify information stored by UDM/UDR 303. The updated priority access information for UE 107 may, for example, add one or more access identities and/or to remove one or more access identities with which UE 107 is associated.

Based on receiving (at 404) the updated priority access information for UE 107, and further based on the subscribing (at 402) of NF 301 to updated priority access information for UE 107, UDM/UDR 303 may automatically output (at 406) the updated priority access information to NF 301. For example, UDM/UDR 303 may “push” the updated priority access information to NF 301. That is, UDM/UDR 303 may output (at 406) the updated priority access information without receiving a request from NF 301 for such information after receiving (at 404) the updated information from management platform 401. As discussed above, NF 301 may utilize the updated priority access information for UE 107 when providing services to UE 107, such as traffic routing, processing, forwarding, etc. services. As discussed above, implementing the updated priority access information may include identifying and/or utilizing QoS parameters associated with the updated priority access information for UE 107.

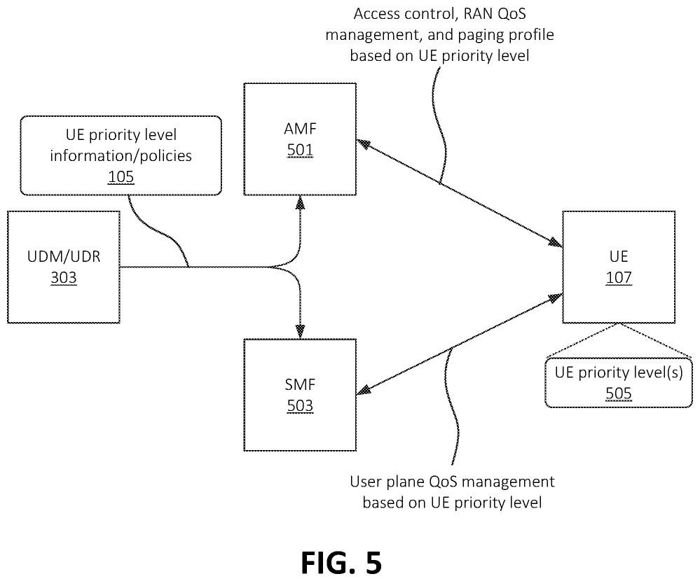

FIG. 5 illustrates an example of particular NFs 301 that may utilize priority access information when providing services to UE 107. For example, as shown, Access and Mobility Management Function (“AMF”) 501 and/or Session Management Function (“SMF”) 503 may receive UE priority level information/policies 105. As discussed above, AMF 501 and SMF 503 may receive such information based on requesting (e.g., at 302) such information from UDM/UDR 303, and/or may automatically receive (e.g., at 406) such information from UDM/UDR 303 in a “push” fashion. As also shown, UE 107 may maintain UE priority level information 505, indicating one or more priority levels with which UE 107 is associated. In some embodiments, UE 107 may maintain such information in a secure subscriber information component, such as a Subscriber Identification Module (“SIM”), a Universal Subscriber Identity Module (“USIM”), a Universal Integrated Circuit Card (“UICC”), an embedded Subscriber Identity Module (“eSIM”), or the like.

AMF 501 may perform access control for one or more UEs 107 based on UE priority level and/or other suitable factors. For example, UE 107 may request access to RAN 101, and may include one or more access identities or other suitable priority level indicators in the request. In some embodiments, UE 107 may include the one or more access identities or other suitable priority level indicators as an Radio Resource Control (“RRC”) establishment cause in one or more RRC messages sent to AMF 501 (e.g., via an N1 interface) when requesting access to RAN 101. AMF 501 may, for example, accept or deny the access request based on the requesting priority level.

Similar concepts discussed above may be applicable when UE priority level information/policies 105, as maintained by AMF 501, do not include UE priority level information for UE 107, and/or when UE priority level information/policies 105 do not indicate that UE 107 is authorized for a requested priority level. That is, in some embodiments, the absence of information indicating that a given UE 107 is associated with a given requested priority level may be used to determine that such UE 107 is authorized for such priority level.

Further, AMF 501 may communicate with one or more other elements of RAN 101, such as a base station (e.g., a Next Generation Node B (“gNB”)), a RAN controller, etc. in order to implement a requested priority level for which UE 107 is authorized. For example, AMF 501 may identify one or more QoS parameters, RAN-specific parameters (e.g., one or more 5QI values), or other suitable parameters associated with the priority level, and may indicate to the base station or other elements of RAN 101 that services provided to UE 107 should be provided in accordance with such QoS parameters. Additionally, or alternatively, AMF 501 may indicate to the base station or other elements of RAN 101 that UE 107 is associated with the requested priority level. In turn the base station or other elements of RAN 101 may implement QoS parameters or other suitable parameters, associated with the requested priority level, when providing services to UE 107. For example, the base station may schedule or allocate radio resources for UE 107 based on the priority level, may designate one or more radio bearers for UE 107 with one or more QCI values, etc.

Additionally, as discussed above, AMF 501 may implement a particular paging profile associated with the requested priority level. For example, AMF 501 may output paging messages, perform location determination techniques, output downlink data notifications, and/or otherwise perform paging operations or other operations in accordance with the requested priority level (e.g., as indicated by UE priority level information/policies 105). As discussed above, the different paging profiles may include paging UE 107 more or less often, setting minimum or maximum thresholds for how often UE 107 is paged, etc.

As another example, UE 107 may request the establishment of one or more communication sessions with core network 103, such as one or more protocol data unit (“PDU”) sessions. In some embodiments, such requests may be received by SMF 503 (e.g., UE 107 may output the requests to AMF 501, which may forward such requests to SMF 503 via an N3 interface or other suitable interface). In accordance with some embodiments, the request may include an identification of one or more access identities. For example, UE 107 may have identified one or more access identities indicated in UE priority level information 505, and may request that the communication session be associated with one or more of such access identities.

SMF 503 may compare the requested access identities to access identities indicated in UE priority level information/policies 105 as being authorized for UE 107, and may accept or deny the request based on the comparing. In situations where UE 107 is authorized for the requested access identity, SMF 503 may perform one or more additional operations and/or may communicate with one or more other network elements (e.g., a User Plane Function (“UPF”), a Policy Control Function (“PCF”), etc.) to facilitate establishment of the requested communication session. In some embodiments, SMF 503 may instruct UPF and/or one or more other elements of core network 103 (e.g., one or more routers, hubs, switches, etc. that route traffic within core network 103) to mark traffic, associated with the requested communication session, with one or more labels, markers, identifiers, etc. that are associated with QoS parameters indicated by UE priority level information/policies 105 as being associated with the requested access identity. In some embodiments, such markings may include Differentiated Services Code Point (“DSCP”) markings or other suitable markings, based on which elements of core network 103 may implement such QoS parameters.

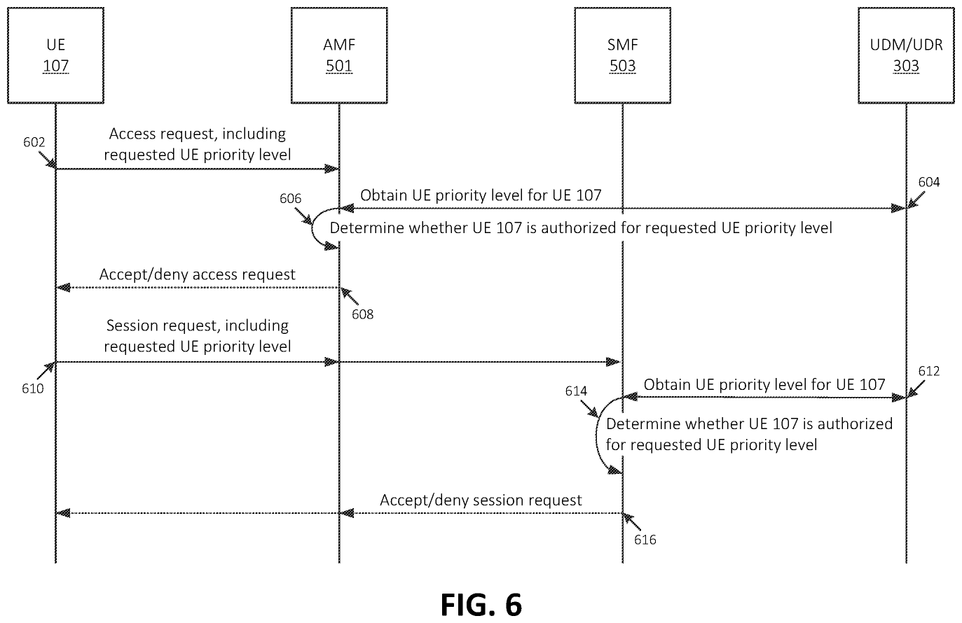

FIG. 6 illustrates an example signal flow for providing subscription-based priority access to one or more UEs 107 in a wireless network. As shown, UE 107 may output (at 602) an access request to AMF 501 (e.g., as part of a connection procedure between UE 107 and RAN 101), which may include a requested priority level. For example, as discussed above, the request may include one or more RRC messages that include an RRC establishment cause that includes one or more requested access identities. AMF 501 may obtain (at 604) subscription information for UE 107 from UDM/UDR 303, which may include one or more priority levels (e.g., access identities) for which UE 107 is authorized. AMF 501 may determine (at 606) whether UE 107 is authorized for the requested priority level based on the subscription information received from UDM/UDR 303. AMF 501 may accept or deny (at 608) the access request based on the determination (at 606) of whether UE 107 is authorized for the requested priority level and/or based on other factors. In some embodiments, AMF 501 may perform one or more other operations based on determining that UE 107 is authorized for the requested priority level, such as implementing one or more corresponding paging profiles with respect to UE 107.

Assuming the access request was accepted (at 608), UE 107 may subsequently output (at 610) a communication session request, such as a PDU session establishment request, to SMF 503. In some embodiments, UE 107 may output the request to AMF 501, which may forward the request to SMF 503. As discussed above, the request (at 610) may include an access identity or other suitable priority level identifier. SMF 503 may obtain (at 612) subscription information for UE 107 from UDM/UDR 303, which may include one or more priority levels (e.g., access identities) for which UE 107 is authorized. SMF 503 may determine (at 614) whether UE 107 is authorized for the requested priority level based on the subscription information received from UDM/UDR 303. SMF 503 may accept or deny (at 616) the session establishment request based on the determination (at 614) of whether UE 107 is authorized for the requested priority level and/or based on other factors. As discussed above, accepting the session establishment request may include communicating with one or more other elements of core network 103 to implement the requested session, such as communicating with a UPF to establish the PDU session between UE 107 and the UPF. In some embodiments, accepting the communication session may include identifying a network slice with which the priority level is associated, and selecting a UPF or other suitable devices or systems that are associated with the identified network slice.

AMF 501 and SMF 503 are presented as example NFs 301 that may request, receive, utilize, etc. priority level information for one or more UEs 107. In some embodiments, other NFs 301 (e.g., in addition to or in lieu of AMF 501 and/or SMF 503) may similarly obtain priority level information associated with one or more UEs 107 (e.g., from UDM/UDR 303), and may implement policies, parameters, etc. associated with such priority levels when providing service to such UEs 107.

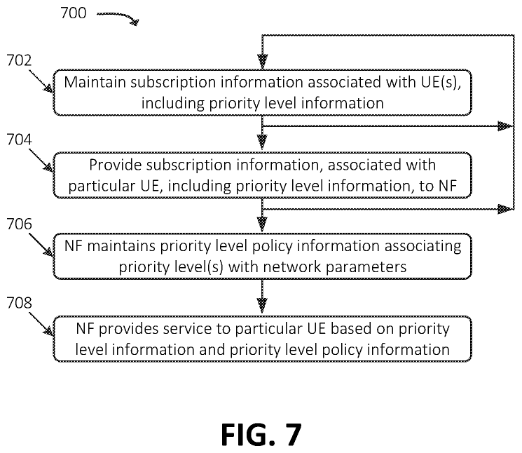

FIG. 7 illustrates an example process 700 for providing subscription-based priority access to a UE in a wireless network. In some embodiments, one or more portions of process 700 may be performed by UDM/UDR 303. In some embodiments, one or more other devices may perform some or all of process 700 in concert with, and/or in lieu of, UDM/UDR 303. For example, one or more NFs 301 may perform one or more operations of process 700.

As shown, process 700 may include maintaining (at 702) subscription information associated with one or more UEs 107, including priority level information. For example, as discussed above, UDM/UDR 303 may receive and maintain subscription information associated with one or more UEs 107 from management platform 401 and/or some other suitable authorized source. The subscription information may include parameters such as device identifiers (e.g., SUPI, GUTI, MDN, etc.), user information, location information, etc. In accordance with some embodiments, the subscription information may include one or more priority level identifiers, such as access identities (e.g., including access identities 11-15).

Process 700 may further include providing (at 704) subscription information, associated with a particular UE 107, to a particular NF 301. For example, as discussed above, NF 301 may request (e.g., at 302) subscription information associated with the particular UE 107 (e.g., based on a triggering event such as a connection request from UE 107), and/or may automatically output or “push” (e.g., at 406) the subscription information to NF 301. The provided subscription information may include one or more priority level identifiers with which the particular UE 107 is associated (e.g., is authorized to use, access, request, etc.).

Process 700 may additionally include maintaining (at 706) priority level policy information associating priority levels with respective network parameters. For example, NF 301 may receive (e.g., from management platform 401 or some other suitable authorized source) priority level policy information (e.g., as shown in data structure 201) associating particular priority level identifiers (e.g., access identities) with particular network parameters (e.g., QoS parameters or other suitable parameters).

Process 700 may also include providing (at 708) service to the particular UE 107 based on the priority level information with which the particular UE 107 is associated, as well as based on the priority level policy information. For example, NF 301 may receive or identify uplink traffic for UE 107 (e.g., traffic sent by UE 107) and/or downlink traffic (e.g., traffic sent to UE 107), and may queue, schedule, process, forward, filter, etc. the traffic in accordance with the priority level information. For example, NF 301 may apply a particular set of QoS parameters, weights, etc. to the traffic based on the priority level information. In this manner, different priority levels may be able to be provided on a per-UE basis, thus enhancing operator control of the network as well as enhancing the user experience of users of UEs 107. Additionally, security is maintained by virtue of subscription information being maintained by a secure network element (e.g., UDM/UDR 303), where such subscription information includes priority level information. In this sense, requests from UEs 107 for access to a particular priority level may be verified by checking the subscription information maintained by the secure network element.

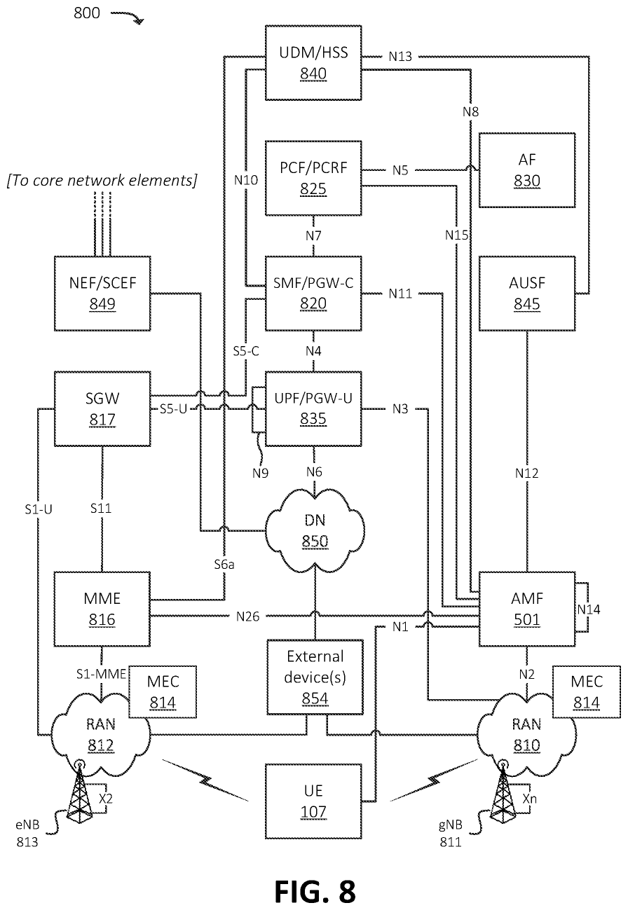

FIG. 8 illustrates an example environment 800, in which one or more embodiments may be implemented. In some embodiments, environment 800 may correspond to a Fifth Generation (“5G”) network, and/or may include elements of a 5G network. In some embodiments, environment 800 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 800 may represent or may include a 5G core (“5GC”). As shown, environment 800 may include UE 107, RAN 810 (which may include one or more gNBs 811), RAN 812 (which may include one or more evolved Node Bs (“eNBs”) 813), and various network functions such as AMF 501, Mobility Management Entity (“MME”) 816, Serving Gateway (“SGW”) 817, SMF/Packet Data Network (“PDN”) Gateway (“PGW”)-Control plane function (“PGW-C”) 820, PCF/Policy Charging and Rules Function (“PCRF”) 825, Application Function (“AF”) 830, UPF/PGW-User plane function (“PGW-U”) 835, UDM/Home Subscriber Server (“HSS”) 840, Authentication Server Function (“AUSF”) 845, and Network Exposure Function (“NEF”)/Service Capability Exposure Function (“SCEF”) 849. Environment 800 may also include one or more networks, such as Data Network (“DN”) 850. Environment 800 may include one or more additional devices or systems communicatively coupled to one or more networks (e.g., DN 850), such as one or more external devices 854.

The example shown in FIG. 8 illustrates one instance of each network component or function (e.g., one instance of SMF/PGW-C 820, PCF/PCRF 825, UPF/PGW-U 835, UDM/HSS 840, and/or AUSF 845). In practice, environment 800 may include multiple instances of such components or functions. For example, in some embodiments, environment 800 may include multiple “slices” of a core network, where each slice includes a discrete and/or logical set of network functions (e.g., one slice may include a first instance of AMF 501, SMF/PGW-C 820, PCF/PCRF 825, and/or UPF/PGW-U 835, while another slice may include a second instance of AMF 501, SMF/PGW-C 820, PCF/PCRF 825, and/or UPF/PGW-U 835). The different slices may provide differentiated levels of service, such as service in accordance with different QoS parameters.

The quantity of devices and/or networks, illustrated in FIG. 8, is provided for explanatory purposes only. In practice, environment 800 may include additional devices and/or networks, fewer devices and/or networks, different devices and/or networks, or differently arranged devices and/or networks than illustrated in FIG. 8. For example, while not shown, environment 800 may include devices that facilitate or enable communication between various components shown in environment 800, such as routers, modems, gateways, switches, hubs, etc. In some implementations, one or more devices of environment 800 may be physically integrated in, and/or may be physically attached to, one or more other devices of environment 800. Alternatively, or additionally, one or more of the devices of environment 800 may perform one or more network functions described as being performed by another one or more of the devices of environment 800.

Additionally, one or more elements of environment 800 may be implemented in a virtualized and/or containerized manner. For example, one or more of the elements of environment 800 may be implemented by one or more Virtualized NFs (“VNFs”), Cloud-Native NFs (“CNFs”), etc. In such embodiments, environment 800 may include, may implement, and/or may be communicatively coupled to an orchestration platform that provisions hardware resources, installs containers or applications, performs load balancing, and/or otherwise manages the deployment of such elements of environment 800. In some embodiments, such orchestration and/or management of such elements of environment 800 may be performed by, or in conjunction with, the open-source Kubernetes® application programming interface (“API”) or some other suitable virtualization, containerization, and/or orchestration system.

Elements of environment 800 may interconnect with each other and/or other devices via wired connections, wireless connections, or a combination of wired and wireless connections. Examples of interfaces or communication pathways between the elements of environment 800, as shown in FIG. 8, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 8, such as Service-Based Interfaces (“SBIs”), including an Namf interface, an Nudm interface, an Npcf interface, an Nupf interface, an Nnef interface, an Nsmf interface, and/or one or more other SBIs. In some embodiments, environment 800 may be, may include, may be implemented by, and/or may be communicatively coupled to RAN 101 and/or core network 103.

UE 107 may include a computation and communication device, such as a wireless mobile communication device that is capable of communicating with RAN 810, RAN 812, and/or DN 850. UE 107 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an IoT device (e.g., a sensor, a smart home appliance, a wearable device, a programmable logic controller or other industrial controller, a Machine-to-Machine (“M2M”) device, or the like), a Fixed Wireless Access (“FWA”) device, or another type of mobile computation and communication device. UE 107 may send traffic to and/or receive traffic (e.g., user plane traffic) from DN 850 via RAN 810, RAN 812, and/or UPF/PGW-U 835.

RAN 810 may be, or may include, a 5G RAN that implements a 5G RAT and that includes one or more base stations (e.g., one or more gNBs 811), via which UE 107 may communicate with one or more other elements of environment 800. UE 107 may communicate with RAN 810 via an air interface (e.g., as provided by gNB 811). For instance, RAN 810 may receive traffic (e.g., user plane traffic such as voice call traffic, data traffic, messaging traffic, etc.) from UE 107 via the air interface, and may communicate the traffic to UPF/PGW-U 835 and/or one or more other devices or networks. Further, RAN 810 may receive signaling traffic, control plane traffic, etc. from UE 107 via the air interface, and may communicate such signaling traffic, control plane traffic, etc. to AMF 501 and/or one or more other devices or networks. Additionally, RAN 810 may receive traffic intended for UE 107 (e.g., from UPF/PGW-U 835, AMF 501, and/or one or more other devices or networks) and may communicate the traffic to UE 107 via the air interface. In some embodiments, RAN 101 may implement, may be implemented by, and/or may otherwise be associated with RAN 810.

RAN 812 may be, or may include, an LTE RAN that implements an LTE RAT and that includes one or more base stations (e.g., one or more eNBs 813), via which UE 107 may communicate with one or more other elements of environment 800. UE 107 may communicate with RAN 812 via an air interface (e.g., as provided by eNB 813). For instance, RAN 812 may receive traffic (e.g., user plane traffic such as voice call traffic, data traffic, messaging traffic, signaling traffic, etc.) from UE 107 via the air interface, and may communicate the traffic to UPF/PGW-U 835 (e.g., via SGW 817) and/or one or more other devices or networks. Further, RAN 812 may receive signaling traffic, control plane traffic, etc. from UE 107 via the air interface, and may communicate such signaling traffic, control plane traffic, etc. to MME 816 and/or one or more other devices or networks. Additionally, RAN 812 may receive traffic intended for UE 107 (e.g., from UPF/PGW-U 835, MME 816, SGW 817, and/or one or more other devices or networks) and may communicate the traffic to UE 107 via the air interface. In some embodiments, RAN 101 may implement, may be implemented by, and/or may otherwise be associated with RAN 812.

One or more RANs of environment 800 (e.g., RAN 810 and/or RAN 812) may include, may implement, and/or may otherwise be communicatively coupled to one or more edge computing devices, such as one or more Multi-Access/Mobile Edge Computing (“MEC”) devices (referred to sometimes herein simply as a “MECs”) 814. MECs 814 may be co-located with wireless network infrastructure equipment of RANs 810 and/or 812 (e.g., one or more gNBs 811 and/or one or more eNBs 813, respectively). Additionally, or alternatively, MECs 814 may otherwise be associated with geographical regions (e.g., coverage areas) of wireless network infrastructure equipment of RANs 810 and/or 812. In some embodiments, one or more MECs 814 may be implemented by the same set of hardware resources, the same set of devices, etc. that implement wireless network infrastructure equipment of RANs 810 and/or 812. In some embodiments, one or more MECs 814 may be implemented by different hardware resources, a different set of devices, etc. from hardware resources or devices that implement wireless network infrastructure equipment of RANs 810 and/or 812. In some embodiments, MECs 814 may be communicatively coupled to wireless network infrastructure equipment of RANs 810 and/or 812 (e.g., via a high-speed and/or low-latency link such as a physical wired interface, a high-speed and/or low-latency wireless interface, or some other suitable communication pathway).

MECs 814 may include hardware resources (e.g., configurable or provisionable hardware resources) that may be configured to provide services and/or otherwise process traffic to and/or from UE 107, via RAN 810 and/or 812. For example, RAN 810 and/or 812 may route some traffic from UE 107 (e.g., traffic associated with one or more particular services, applications, application types, etc.) to a respective MEC 814 instead of to core network elements of 800 (e.g., UPF/PGW-U 835). MEC 814 may accordingly provide services to UE 107 by processing such traffic, performing one or more computations based on the received traffic, and providing traffic to UE 107 via RAN 810 and/or 812. MEC 814 may include, and/or may implement, some or all of the functionality described above with respect to UPF/PGW-U 835, AF 830, one or more application servers, and/or one or more other devices, systems, VNFs, CNFs, etc. In this manner, ultra-low latency services may be provided to UE 107, as traffic does not need to traverse links (e.g., backhaul links) between RAN 810 and/or 812 and the core network.

AMF 501 may include one or more devices, systems, VNFs, CNFs, etc., that perform operations to register UE 107 with the 5G network, to establish bearer channels associated with a session with UE 107, to hand off UE 107 from the 5G network to another network, to hand off UE 107 from the other network to the 5G network, manage mobility of UE 107 between RANs 810 and/or gNBs 811, and/or to perform other operations. In some embodiments, the 5G network may include multiple AMFs 501, which communicate with each other via the N14 interface (denoted in FIG. 8 by the line marked “N14” originating and terminating at AMF 501).

MME 816 may include one or more devices, systems, VNFs, CNFs, etc., that perform operations to register UE 107 with the EPC, to establish bearer channels associated with a session with UE 107, to hand off UE 107 from the EPC to another network, to hand off UE 107 from another network to the EPC, manage mobility of UE 107 between RANs 812 and/or eNBs 813, and/or to perform other operations.

SGW 817 may include one or more devices, systems, VNFs, CNFs, etc., that aggregate traffic received from one or more eNBs 813 and send the aggregated traffic to an external network or device via UPF/PGW-U 835. Additionally, SGW 817 may aggregate traffic received from one or more UPF/PGW-Us 835 and may send the aggregated traffic to one or more eNBs 813. SGW 817 may operate as an anchor for the user plane during inter-eNB handovers and as an anchor for mobility between different telecommunication networks or RANs (e.g., RANs 810 and 812).

SMF/PGW-C 820 may include one or more devices, systems, VNFs, CNFs, etc., that gather, process, store, and/or provide information in a manner described herein. SMF/PGW-C 820 may, for example, facilitate the establishment of communication sessions on behalf of UE 107. In some embodiments, the establishment of communications sessions may be performed in accordance with one or more policies provided by PCF/PCRF 825.

PCF/PCRF 825 may include one or more devices, systems, VNFs, CNFs, etc., that aggregate information to and from the 5G network and/or other sources. PCF/PCRF 825 may receive information regarding policies and/or subscriptions from one or more sources, such as subscriber databases and/or from one or more users (such as, for example, an administrator associated with PCF/PCRF 825).

AF 830 may include one or more devices, systems, VNFs, CNFs, etc., that receive, store, and/or provide information that may be used in determining parameters (e.g., quality of service parameters, charging parameters, or the like) for certain applications.

UPF/PGW-U 835 may include one or more devices, systems, VNFs, CNFs, etc., that receive, store, and/or provide data (e.g., user plane data). For example, UPF/PGW-U 835 may receive user plane data (e.g., voice call traffic, data traffic, etc.), destined for UE 107, from DN 850, and may forward the user plane data toward UE 107 (e.g., via RAN 810, SMF/PGW-C 820, and/or one or more other devices). In some embodiments, multiple instances of UPF/PGW-U 835 may be deployed (e.g., in different geographical locations), and the delivery of content to UE 107 may be coordinated via the N9 interface (e.g., as denoted in FIG. 8 by the line marked “N9” originating and terminating at UPF/PGW-U 835). Similarly, UPF/PGW-U 835 may receive traffic from UE 107 (e.g., via RAN 810, RAN 812, SMF/PGW-C 820, and/or one or more other devices), and may forward the traffic toward DN 850. In some embodiments, UPF/PGW-U 835 may communicate (e.g., via the N4 interface) with SMF/PGW-C 820, regarding user plane data processed by UPF/PGW-U 835.

UDM/HSS 840 and AUSF 845 may include one or more devices, systems, VNFs, CNFs, etc., that manage, update, and/or store, in one or more memory devices associated with AUSF 845 and/or UDM/HSS 840, profile information associated with a subscriber. In some embodiments, UDM/HSS 840 may include, may implement, may be communicatively coupled to, and/or may otherwise be associated with some other type of repository or database, such as a UDR. For example, UDM/UDR 303 may perform some or all of the functions of UDM/HSS 840, and/or UDM/HSS 840 may perform some or all of the functions of UDM/UDR 303. AUSF 845 and/or UDM/HSS 840 may perform authentication, authorization, and/or accounting operations associated with one or more UEs 107 and/or one or more communication sessions associated with one or more UEs 107.

DN 850 may include one or more wired and/or wireless networks. For example, DN 850 may include an Internet Protocol (“IP”)-based PDN, a wide area network (“WAN”) such as the Internet, a private enterprise network, and/or one or more other networks. UE 107 may communicate, through DN 850, with data servers, other UEs 107, and/or to other servers or applications that are coupled to DN 850. DN 850 may be connected to one or more other networks, such as a public switched telephone network (“PSTN”), a public land mobile network (“PLMN”), and/or another network. DN 850 may be connected to one or more devices, such as content providers, applications, web servers, and/or other devices, with which UE 107 may communicate.

External devices 854 may include one or more devices or systems that communicate with UE 107 via DN 850 and one or more elements of 800 (e.g., via UPF/PGW-U 835). In some embodiments, external devices 854 may include, may implement, and/or may otherwise be associated with management platform 401. External devices 854 may include, for example, one or more application servers, content provider systems, web servers, or the like. External devices 854 may, for example, implement “server-side” applications that communicate with “client-side” applications executed by UE 107. External devices 854 may provide services to UE 107 such as gaming services, videoconferencing services, messaging services, email services, web services, and/or other types of services.

In some embodiments, external devices 854 may communicate with one or more elements of environment 800 (e.g., core network elements) via NEF/SCEF 849. NEF/SCEF 849 include one or more devices, systems, VNFs, CNFs, etc. that provide access to information, APIs, and/or other operations or mechanisms of one or more core network elements to devices or systems that are external to the core network (e.g., to external device 854 via DN 850). NEF/SCEF 849 may maintain authorization and/or authentication information associated with such external devices or systems, such that NEF/SCEF 849 is able to provide information, that is authorized to be provided, to the external devices or systems. For example, a given external device 854 may request particular information associated with one or more core network elements. NEF/SCEF 849 may authenticate the request and/or otherwise verify that external device 854 is authorized to receive the information, and may request, obtain, or otherwise receive the information from the one or more core network elements. In some embodiments, NEF/SCEF 849 may include, may implement, may be implemented by, may be communicatively coupled to, and/or may otherwise be associated with a Security Edge Protection Proxy (“SEPP”), which may perform some or all of the functions discussed above. External device 854 may, in some situations, subscribe to particular types of requested information provided by the one or more core network elements, and the one or more core network elements may provide (e.g., “push”) the requested information to NEF/SCEF 849 (e.g., in a periodic or otherwise ongoing basis).

In some embodiments, external devices 854 may communicate with one or more elements of RAN 810 and/or 812 via an API or other suitable interface. For example, a given external device 854 may provide instructions, requests, etc. to RAN 810 and/or 812 to provide one or more services via one or more respective MECs 814. In some embodiments, such instructions, requests, etc. may include QoS parameters, Service Level Agreements (“SLAs”), etc. (e.g., maximum latency thresholds, minimum throughput thresholds, etc.) associated with the services.

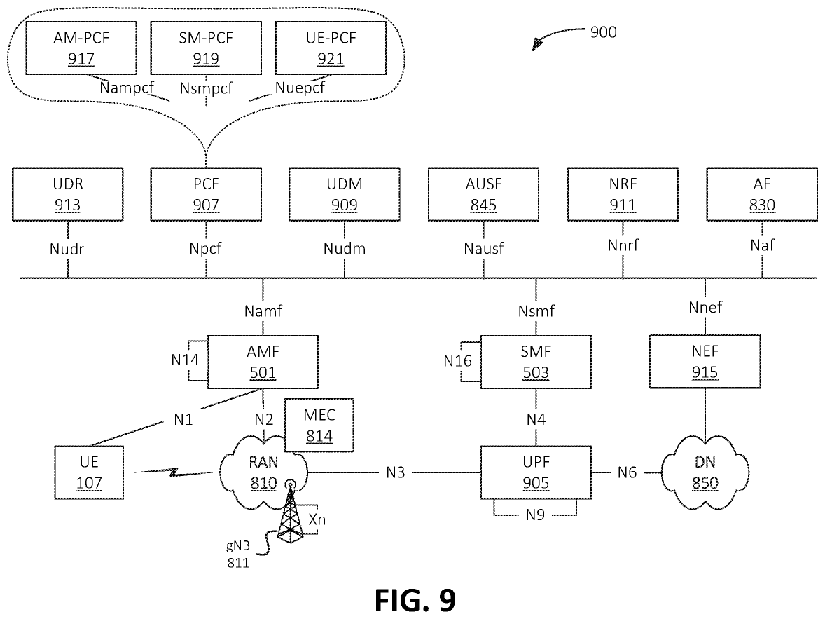

FIG. 9 illustrates another example environment 900, in which one or more embodiments may be implemented. In some embodiments, environment 900 may correspond to a 5G network, and/or may include elements of a 5G network. In some embodiments, environment 900 may correspond to a 5G SA architecture. In some embodiments, environment 900 may include a 5GC, in which 5GC network elements perform one or more operations described herein.

As shown, environment 900 may include UE 107, RAN 810 (which may include one or more gNBs 811 or other types of wireless network infrastructure) and various network functions, which may be implemented as VNFs, CNFs, etc. Such network functions may include AMF 501, SMF 503, UPF 905, PCF 907, UDM 909, AUSF 845, Network Repository Function (“NRF”) 911, AF 830, UDR 913, and NEF 915. Environment 900 may also include or may be communicatively coupled to one or more networks, such as DN 850.

The example shown in FIG. 9 illustrates one instance of each network component or function (e.g., one instance of SMF 503, UPF 905, PCF 907, UDM 909, AUSF 845, etc.). In practice, environment 900 may include multiple instances of such components or functions. For example, in some embodiments, environment 900 may include multiple “slices” of a core network, where each slice includes a discrete and/or logical set of network functions (e.g., one slice may include a first instance of SMF 503, PCF 907, UPF 905, etc., while another slice may include a second instance of SMF 503, PCF 907, UPF 905, etc.). Additionally, or alternatively, one or more of the network functions of environment 900 may implement multiple network slices. The different slices may provide differentiated levels of service, such as service in accordance with different QoS parameters.

The quantity of devices and/or networks, illustrated in FIG. 9, is provided for explanatory purposes only. In practice, environment 900 may include additional devices and/or networks, fewer devices and/or networks, different devices and/or networks, or differently arranged devices and/or networks than illustrated in FIG. 9. For example, while not shown, environment 900 may include devices that facilitate or enable communication between various components shown in environment 900, such as routers, modems, gateways, switches, hubs, etc. In some implementations, one or more devices of environment 900 may be physically integrated in, and/or may be physically attached to, one or more other devices of environment 900. Alternatively, or additionally, one or more of the devices of environment 900 may perform one or more network functions described as being performed by another one or more of the devices of environment 900.

Elements of environment 900 may interconnect with each other and/or other devices via wired connections, wireless connections, or a combination of wired and wireless connections. Examples of interfaces or communication pathways between the elements of environment 900, as shown in FIG. 9, may include interfaces shown in FIG. 9 and/or one or more interfaces not explicitly shown in FIG. 9. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 900 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 501), an Nudm interface (e.g., indicating communications to be routed to UDM 909), an Npcf interface, an Nupf interface, an Nnef interface, an Nsmf interface, an Nnrf interface, an Nudr interface, an Naf interface, and/or one or more other SBIs. In some embodiments, environment 900 may be, may include, may be implemented by, and/or may be communicatively coupled to RAN 101 and/or core network 103.

UPF 905 may include one or more devices, systems, VNFs, CNFs, etc., that receive, route, process, and/or forward traffic (e.g., user plane traffic). As discussed above, UPF 905 may communicate with UE 107 via one or more communication sessions, such as PDU sessions. Such PDU sessions may be associated with a particular network slice or other suitable QoS parameters, as noted above. UPF 905 may receive downlink user plane traffic (e.g., voice call traffic, data traffic, etc. destined for UE 107) from DN 850, and may forward the downlink user plane traffic toward UE 107 (e.g., via RAN 810). In some embodiments, multiple UPFs 905 may be deployed (e.g., in different geographical locations), and the delivery of content to UE 107 may be coordinated via the N9 interface. Similarly, UPF 905 may receive uplink traffic from UE 107 (e.g., via RAN 810), and may forward the traffic toward DN 850. In some embodiments, UPF 905 may implement, may be implemented by, may be communicatively coupled to, and/or may otherwise be associated with UPF/PGW-U 835. In some embodiments, UPF 905 may communicate (e.g., via the N4 interface) with SMF 503, regarding user plane data processed by UPF 905 (e.g., to provide analytics or reporting information, to receive policy and/or authorization information, etc.).

PCF 907 may include one or more devices, systems, VNFs, CNFs, etc., that aggregate, derive, generate, etc. policy information associated with the 5GC and/or UEs 107 that communicate via the 5GC and/or RAN 810. PCF 907 may receive information regarding policies and/or subscriptions from one or more sources, such as subscriber databases (e.g., UDM 909, UDR 913, etc.), and/or from one or more users such as, for example, an administrator associated with PCF 907. In some embodiments, the functionality of PCF 907 may be split into multiple network functions or subsystems, such as access and mobility PCF (“AM-PCF”) 917, session management PCF (“SM-PCF”) 919, UE PCF (“UE-PCF”) 921, and so on. Such different “split” PCFs may be associated with respective SBIs (e.g., AM-PCF 917 may be associated with an Nampcf SBI, SM-PCF 919 may be associated with an Nsmpcf SBI, UE-PCF 921 may be associated with an Nuepcf SBI, and so on) via which other network functions may communicate with the split PCFs. The split PCFs may maintain information regarding policies associated with different devices, systems, and/or network functions.

NRF 911 may include one or more devices, systems, VNFs, CNFs, etc. that maintain routing and/or network topology information associated with the 5GC. For example, NRF 911 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 913 may include one or more devices, systems, VNFs, CNFs, etc. that provide user and/or subscriber information, based on which PCF 907 and/or other elements of environment 900 may determine access policies, QoS policies, charging policies, or the like. In some embodiments, UDR 913 may receive such information from UDM 909 and/or one or more other sources. In some embodiments, UDM/UDR 303 may include, may implement, may be implemented by, may be communicatively coupled to, and/or may otherwise be associated with UDM 909 and/or UDR 913.

NEF 915 include one or more devices, systems, VNFs, CNFs, etc. that provide access to information, APIs, and/or other operations or mechanisms of the 5GC to devices or systems that are external to the 5GC. NEF 915 may maintain authorization and/or authentication information associated with such external devices or systems, such that NEF 915 is able to provide information, that is authorized to be provided, to the external devices or systems. Such information may be received from other network functions of the 5GC (e.g., as authorized by an administrator or other suitable entity associated with the 5GC), such as SMF 503, UPF 905, a charging function (“CHF”) of the 5GC, and/or other suitable network function. NEF 915 may communicate with external devices or systems (e.g., external devices 854) via DN 850 and/or other suitable communication pathways.

While environment 900 is described in the context of a 5GC, as noted above, environment 900 may, in some embodiments, include or implement one or more other types of core networks. For example, in some embodiments, environment 900 may be or may include a converged packet core, in which one or more elements may perform some or all of the functionality of one or more 5GC network functions and/or one or more EPC network functions. For example, in some embodiments, AMF 501 may include, may implement, may be implemented by, and/or may otherwise be associated with MME 816; SMF 503 may include, may implement, may be implemented by, and/or may otherwise be associated with SGW 817; PCF 907 may include, may implement, may be implemented by, and/or may otherwise be associated with a PCRF (e.g., PCF/PCRF 825); NEF 915 may include, may implement, may be implemented by, and/or may otherwise be associated with a SCEF (e.g., NEF/SCEF 849); and so on.

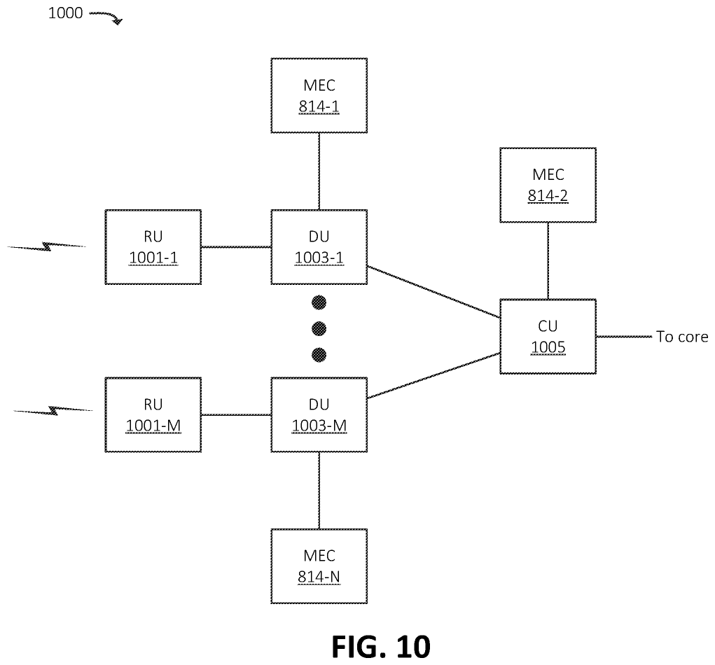

FIG. 10 illustrates an example RAN environment 1000, which may be included in and/or implemented by one or more RANs (e.g., RAN 810 or some other RAN). In some embodiments, a particular RAN 810 may include one RAN environment 1000. In some embodiments, a particular RAN 810 may include multiple RAN environments 1000. In some embodiments, RAN environment 1000 may correspond to a particular gNB 811 of RAN 810. In some embodiments, RAN environment 1000 may correspond to multiple gNBs 811. In some embodiments, RAN environment 1000 may correspond to one or more other types of base stations of one or more other types of RANs. As shown, RAN environment 1000 may include Central Unit (“CU”) 1005, one or more Distributed Units (“DUs”) 1003-1 through 1003-M (referred to individually as “DU 1003,” or collectively as “DUs 1003”), and one or more Radio Units (“RUs”) 1001-1 through 1001-M (referred to individually as “RU 1001,” or collectively as “RUs 1001”).

CU 1005 may communicate with a core of a wireless network (e.g., may communicate with one or more of the devices or systems described above with respect to FIG. 9, such as AMF 501 and/or UPF 905) and/or some other device or system such as MEC 814. In the uplink direction (e.g., for traffic from UEs 107 to a core network), CU 1005 may aggregate traffic from DUs 1003, and forward the aggregated traffic to the core network. In some embodiments, CU 1005 may receive traffic according to a given protocol (e.g., Radio Link Control (“RLC”) traffic) from DUs 1003, and may perform higher-layer processing (e.g., may aggregate/process RLC packets and generate Packet Data Convergence Protocol (“PDCP”) packets based on the RLC packets) on the traffic received from DUs 1003.

CU 1005 may receive downlink traffic (e.g., traffic from the core network, traffic from a given MEC 814, etc.) for a particular UE 107, and may determine which DU(s) 1003 should receive the downlink traffic. DU 1003 may include one or more devices that transmit traffic between a core network (e.g., via CU 1005) and UE 107 (e.g., via a respective RU 1001). DU 1003 may, for example, receive traffic from RU 1001 at a first layer (e.g., physical (“PHY”) layer traffic, or lower PHY layer traffic), and may process/aggregate the traffic to a second layer (e.g., upper PHY and/or RLC). DU 1003 may receive traffic from CU 1005 at the second layer, may process the traffic to the first layer, and provide the processed traffic to a respective RU 1001 for transmission to UE 107.

RU 1001 may include hardware circuitry (e.g., one or more RF transceivers, antennas, radios, and/or other suitable hardware) to communicate wirelessly (e.g., via an RF interface) with one or more UEs 107, one or more other DUs 1003 (e.g., via RUs 1001 associated with DUs 1003), and/or any other suitable type of device. In the uplink direction, RU 1001 may receive traffic from UE 107 and/or another DU 1003 via the RF interface and may provide the traffic to DU 1003. In the downlink direction, RU 1001 may receive traffic from DU 1003, and may provide the traffic to UE 107 and/or another DU 1003.

One or more elements of RAN environment 1000 may, in some embodiments, be communicatively coupled to one or more MECs 814. For example, DU 1003-1 may be communicatively coupled to MEC 814-1, DU 1003-M may be communicatively coupled to MEC 814-N, CU 1005 may be communicatively coupled to MEC 814-2, and so on. MECs 814 may include hardware resources (e.g., configurable or provisionable hardware resources) that may be configured to provide services and/or otherwise process traffic to and/or from UE 107, via a respective RU 1001.

For example, DU 1003-1 may route some traffic, from UE 107, to MEC 814-1 instead of to a core network via CU 1005. MEC 814-1 may process the traffic, perform one or more computations based on the received traffic, and may provide traffic to UE 107 via RU 1001-1. As discussed above, MEC 814 may include, and/or may implement, some or all of the functionality described above with respect to UPF 905, AF 830, and/or one or more other devices, systems, VNFs, CNFs, etc. In this manner, ultra-low latency services may be provided to UE 107, as traffic does not need to traverse DU 1003, CU 1005, links between DU 1003 and CU 1005, and an intervening backhaul network between RAN environment 1000 and the core network.

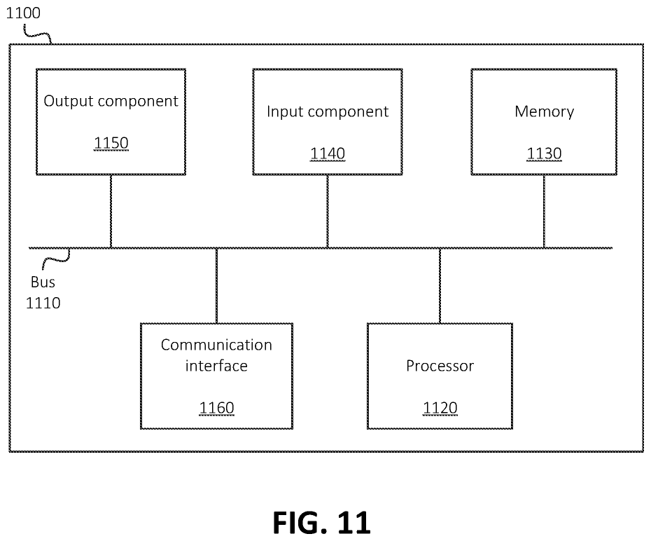

FIG. 11 illustrates example components of device 1100. One or more of the devices described above may include one or more devices 1100. Device 1100 may include bus 1110, processor 1120, memory 1130, input component 1140, output component 1150, and communication interface 1160. In another implementation, device 1100 may include additional, fewer, different, or differently arranged components.

Bus 1110 may include one or more communication paths that permit communication among the components of device 1100. Processor 1120 may include a processor, microprocessor, a set of provisioned hardware resources of a cloud computing system, or other suitable type of hardware that interprets and/or executes instructions (e.g., processor-executable instructions). In some embodiments, processor 1120 may be or may include one or more hardware processors. Memory 1130 may include any type of dynamic storage device that may store information and instructions for execution by processor 1120, and/or any type of non-volatile storage device that may store information for use by processor 1120.

Input component 1140 may include a mechanism that permits an operator to input information to device 1100 and/or other receives or detects input from a source external to input component 1140, such as a touchpad, a touchscreen, a keyboard, a keypad, a button, a switch, a microphone or other audio input component, etc. In some embodiments, input component 1140 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1150 may include a mechanism that outputs information to the operator, such as a display, a speaker, one or more light emitting diodes (“LEDs”), etc.

Communication interface 1160 may include any transceiver-like mechanism that enables device 1100 to communicate with other devices and/or systems (e.g., via RAN 810, RAN 812, DN 850, etc.). For example, communication interface 1160 may include an Ethernet interface, an optical interface, a coaxial interface, or the like. Communication interface 1160 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 1100 may include more than one communication interface 1160. For instance, device 1100 may include an optical interface, a wireless interface, an Ethernet interface, and/or one or more other interfaces.

Device 1100 may perform certain operations relating to one or more processes described above. Device 1100 may perform these operations in response to processor 1120 executing instructions, such as software instructions, processor-executable instructions, etc. stored in a computer-readable medium, such as memory 1130. A computer-readable medium may be defined as a non-transitory memory device. A memory device may include space within a single physical memory device or spread across multiple physical memory devices. The instructions may be read into memory 1130 from another computer-readable medium or from another device. The instructions stored in memory 1130 may be processor-executable instructions that cause processor 1120 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-7), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
maintain subscription information associated with a plurality of User Equipment (“UEs”), wherein the subscription information includes priority level information associating one or more UEs with one or more respective priority levels;
receive, from a network function (“NF”) of a wireless network, a request for priority level information associated with a particular UE;
identify a particular set of priority levels indicated by the subscription information as being associated with the particular UE; and
output, to the NF, the identified particular set of priority levels, wherein the NF maintains policy information associating the particular set of priority levels with one or more network parameters and implements the one or more network parameters when providing service associated with the particular UE.

2. The device of claim 1, wherein implementing the one or more network parameters includes:
identifying a particular set of Quality of Service (“QoS”) parameters with which a particular priority level, of the particular set of priority levels, is associated;
identifying particular traffic that is sent to or by the particular UE; and
implementing the particular set of QoS parameters with respect to the particular traffic sent to or by the particular UE.

3. The device of claim 1, wherein the particular set of priority levels includes one or more access identities.

4. The device of claim 3, wherein the subscription information includes information associating one or more UE identifiers with one or more respective access identities.

5. The device of claim 4, wherein the one or more UE identifiers include a particular Subscription Permanent Identifier (“SUPI”) associated with the particular UE.

6. The device of claim 1, wherein the subscription information is maintained by at least one of:
a Unified Data Management function (“UDM”), or
a Unified Data Repository (“UDR”).

7. The device of claim 1, wherein the NF includes an Access and Mobility Management Function (“AMF”), wherein the one or more network parameters include a particular paging profile that is associated with a particular priority level of the particular set of priority levels, wherein the AMF performs paging operations with respect to the particular UE based on the particular paging profile.

8. A non-transitory computer-readable medium, storing a plurality of processor-executable instructions to:
maintain subscription information associated with a plurality of User Equipment (“UEs”), wherein the subscription information includes priority level information associating one or more UEs with one or more respective priority levels;
receive, from a network function (“NF”) of a wireless network, a request for priority level information associated with a particular UE;
identify a particular set of priority levels indicated by the subscription information as being associated with the particular UE; and
output, to the NF, the identified particular set of priority levels, wherein the NF maintains policy information associating the particular set of priority levels with one or more network parameters and implements the one or more network parameters when providing service associated with the particular UE.

9. The non-transitory computer-readable medium of claim 8, wherein implementing the one or more network parameters includes:
identifying a particular set of Quality of Service (“QoS”) parameters with which a particular priority level, of the particular set of priority levels, is associated;
identifying particular traffic that is sent to or by the particular UE; and
implementing the particular set of QoS parameters with respect to the particular traffic sent to or by the particular UE.

10. The non-transitory computer-readable medium of claim 8, wherein the particular set of priority levels includes one or more access identities.

11. The non-transitory computer-readable medium of claim 10, wherein the subscription information includes information associating one or more UE identifiers with one or more respective access identities.

12. The non-transitory computer-readable medium of claim 11, wherein the one or more UE identifiers include a particular Subscription Permanent Identifier (“SUPI”) associated with the particular UE.

13. The non-transitory computer-readable medium of claim 8, wherein the subscription information is maintained by at least one of:
a Unified Data Management function (“UDM”), or
a Unified Data Repository (“UDR”).

14. The non-transitory computer-readable medium of claim 8, wherein the NF includes an Access and Mobility Management Function (“AMF”), wherein the one or more network parameters include a particular paging profile that is associated with a particular priority level of the particular set of priority levels, wherein the AMF performs paging operations with respect to the particular UE based on the particular paging profile.

15. A method, comprising:
maintaining subscription information associated with a plurality of User Equipment (“UEs”), wherein the subscription information includes priority level information associating one or more UEs with one or more respective priority levels;
receiving, from a network function (“NF”) of a wireless network, a request for priority level information associated with a particular UE;
identifying a particular set of priority levels indicated by the subscription information as being associated with the particular UE; and
outputting, to the NF, the identified particular set of priority levels, wherein the NF maintains policy information associating the particular set of priority levels with one or more network parameters and implements the one or more network parameters when providing service associated with the particular UE.

16. The method of claim 15, wherein implementing the one or more network parameters includes:
identifying a particular set of Quality of Service (“QoS”) parameters with which a particular priority level, of the particular set of priority levels, is associated;
identifying particular traffic that is sent to or by the particular UE; and
implementing the particular set of QoS parameters with respect to the particular traffic sent to or by the particular UE.

17. The method of claim 15, wherein the particular set of priority levels includes one or more access identities.

18. The method of claim 17, wherein the subscription information includes information associating one or more UE identifiers with one or more respective access identities, and wherein the one or more UE identifiers include a particular Subscription Permanent Identifier (“SUPI”) associated with the particular UE.

19. The method of claim 15, wherein the subscription information is maintained by at least one of:
a Unified Data Management function (“UDM”), or
a Unified Data Repository (“UDR”).

20. The method of claim 15, wherein the NF includes an Access and Mobility Management Function (“AMF”), wherein the one or more network parameters include a particular paging profile that is associated with a particular priority level of the particular set of priority levels, wherein the AMF performs paging operations with respect to the particular UE based on the particular paging profile.
